(19) United States
(12) Patent Application Publication
(10) Pub. No.: US 2025/0150721 A1
(43) Pub. Date: May 8, 2025

(54) METHOD AND OPTICAL DEVICE FOR ACQUIRING FRAMES USING A PLURALITY OF DETECTION CHANNELS

(71) Applicant: CARL ZEISS MICROSCOPY GMBH, Jena (DE)

(72) Inventors: Gerd Heisse, Jena (DE); Toni Feuchert, Jena (DE); Joerg Lippold, Weida (DE)

(21) Appl. No.: 18/939,071

(22) Filed: Nov. 6, 2024

(30) Foreign Application Priority Data
Nov. 7, 2023 (DE) 10 2023 211 032.6

(51) Int. Cl. H04N 23/957; G02B 21/36; H04N 23/661; H04N 23/667

(52) U.S. Cl. CPC H04N 23/957; G02B 21/367; H04N 23/661; H04N 23/667

(57) ABSTRACT

Disclosed are techniques for acquiring frames using a plurality of detection channels, including the steps of acquiring first frame data using a first detection channel in a first acquisition mode and of acquiring second frame data using a second detection channel in a second acquisition mode, where the first frame data and the second frame data are acquired in respectively mutually alternating acquisition sequences of a respective acquisition series. The duration of the acquisition sequences of the acquisition series is chosen differently for each detection channel, with the duration of the acquisition sequences in one of the acquisition modes differing from the duration of the acquisition sequences of the at least one further acquisition mode at least by the duration of a single frame acquisition. An optical device can acquire frames using a plurality of detection channels.

### CROSS REFERENCE TO RELATED APPLICATIONS

This application claims priority to German Application No. 10 2023 211 032.6, filed Nov. 7, 2023, the disclosure of which is incorporated herein by reference in its entirety.

### TECHNICAL FIELD

This disclosure relates to methods for acquiring frames using a plurality of detection channels, to optical devices configured to carry out the methods, and to a microscope.

### BACKGROUND

In camera-based optical systems, for example, in microscopes operated as wide-field microscopes or light-field microscopes, a minimum exposure time necessary and a maximum data transfer rate represent limitations for a maximum frame acquisition rate (frame rate). A respectively maximum frame rate can be achieved in the case of a multi-colour recording by virtue of a sample to be imaged being appropriately illuminated using different wavelengths and the different colour channels (detection channels) being acquired simultaneously using a plurality of cameras. A disadvantage in this case lies in the need for a plurality of cameras and in possible crosstalk between the colour channels.

### SUMMARY

The frames of the individual detection channels can be acquired in alternation should the intention be to use only one camera for the acquisition of multi-colour recordings. This reduces the maximally achievable channel-specific frame rate to a value arising from the maximum frame rate of the camera divided by the number of detection channels and arising as a consequence of technical limitations of the frame recording system, for example, a limitation of the bandwidth available.

The problem addressed by the techniques disclosed here is that of proposing an option for acquiring frames using a plurality of detection channels, in the case of which an efficient equipment design and high data quality can be achieved.

The problem is solved, for example, by a method in which frames are acquired using a plurality of detection channels. The method includes the steps described hereinafter. First frame data from a first detection channel are acquired in one step. The acquisition by means of the first detection channel can also be referred to as first acquisition mode. In a further step, second frame data from a second detection channel are acquired (also: second acquisition mode). In this case, the first frame data and the second frame data are acquired in mutually alternating acquisition sequences of a respective acquisition series. A plurality of frames are acquired during an acquisition series. The acquisition series comprises at least one acquisition sequence (see below with regards to FIGS. 1 and 2).

An example method is characterized in that the duration of the acquisition sequences of the acquisition series is chosen differently for each detection channel. In this case, the temporal length—and hence the duration—of the acquisition sequences in one of the acquisition modes differs at least by the duration of a single frame acquisition from the duration of the acquisition sequences of the at least one further acquisition mode. Different durations of the acquisition sequences therefore require a respectively different number of acquired individual frames for each acquisition sequence of the acquisition modes.

Examples are described hereinafter on the basis of two acquisition modes. However, further acquisition modes, for example three, four, five or more acquisition modes are also contemplated.

As a simplification, an acquisition mode is understood here to mean the recording of frames, i.e., the acquisition of a detection radiation, with different information content. Thus, frame data of different origin, for example, fluorescence radiation from different fluorophores, can be acquired in the individual acquisition modes. For example, different acquisition modes can be effected by virtue of making available different illumination wavelengths (excitation radiation) which excite different fluorophores to emit fluorescence radiation. This may take place simultaneously. Optionally, fluorophores need to be activated before their excitation, i.e., be converted from an inactive state to an excitable state. For example, activation can be implemented using a suitable activation radiation. Reflected and/or transmitted illumination radiation can also serve as detection radiation. In this case, the type of alignment and/or shaping of the illumination radiation, for example, can be modified in the individual acquisition modes. For example, it is possible to switch between reflected light and transmitted light illumination, between bright field and dark field illumination, and/or between, different illumination angles and/or illumination directions in order to realize respectively different acquisition modes.

The interplay of the controller with the camera and optionally the light source(s) and further optically effective elements in order to bring about the procedure specified described herein. The assumption is made that the camera permits frame acquisition at only one frame rate. For example, different acquisition modes or detection channels can be realized by virtue of appropriate measures for selecting the acquired frame data, for example the use of wavelength-specific filters, being taken in the illumination beam path and/or in the detection beam path.

The acquisition series have the same duration and run simultaneously in a preferred configuration of the method. It is advantageously possible to realize at least two acquisition modes using only one camera since the acquisition sequences take place in alternation with one another within the acquisition series. Since the acquisition series take place simultaneously and have the same length, they both have data gaps at the time at which frames are acquired in a respective acquisition sequence by means of the respectively other detection channel. A data gap refers to a period of time during an acquisition series during which no current frame data are acquired using the relevant acquisition mode, and which thus corresponds to a number of omitted frames for this acquisition mode.

The availability of a frame for all times within the entire acquisition series and/or the capability of displaying same may be needed in the context of the result of the procedure for the frame acquisition. To this end, in an example implementation, artificial frame data are in each case generated for the data gaps that are caused by the alternate acquisition of first and second frame data and that correspond to at least one omitted frame. This can be implemented in two ways. In a first variant, frame data acquired temporally before, and/or temporally after, a data gap are copied and assigned to the omitted frames. Thus, the data gaps are filled using actual frame data from a time period not corresponding to the data gap. This variant of the method requires less computational power but slightly increases the need for storage space.

In a second variant, data gaps are filled by virtue of frame data for the omitted frames being calculated on the basis of frame data from a detection channel acquired temporally before and/or temporally after a data gap. For example, the frame data acquired before and after a data gap can be used to create frame data for filling the data gap by means of interpolation. Accordingly, this variant requires increased computational power and storage space.

An advantage of both aforementioned variants is that known algorithms can handle such frame series without further adjustments.

Another implementation includes assigning information (metadata) to the frame data and the data gaps. In particular, such metadata may contain information regarding the duration of the acquisition sequences and of the data gaps and the number of acquired or omitted frames.

In this way, information about acquired or omitted frames and the associated times or time periods (timestamps) can be provided, for example, for display and evaluation algorithms. Metadata can be created for the acquisition series, either on an optional basis or at all times, and can be assigned to the frame data.

Another implementation makes use of the information regarding the intensities of the acquired frames. For example, if the intensity values of the frames in the various detection channels are very different, then the acquired sequences can also be adapted in this respect, with the result that, for example, more images are acquired in each case per acquisition sequence in an acquisition mode with a low intensity of the acquired frames than in an acquisition mode with frames of high intensity.

The techniques described herein advantageously allow for the realization of at least two acquisition modes using only one camera, even if only limited bandwidth is available for data transfer. In the process, it is advantageously possible to flexibly match, within the scope of the technical specifications of the camera, the durations and the relative alternating series of the acquisition sequences to the known or expected processes to be observed. Thus, it is possible to observe a fast-moving process in one of the acquisition modes. To this end, the acquisition sequences of this acquisition mode can be chosen in quick succession. Moreover, in a manner corresponding to an acquisition sequence, their respective duration can be chosen to be longer than that of the acquisition sequences of a further acquisition mode intended to be used to image a process that unfolds more slowly, for example, a movement of an element to be observed of the sample. The process that unfolds more slowly can be recorded using frames of shorter and temporally more spaced apart acquisition sequences.

It is also possible to modify the duration of the acquisition sequences over a plurality of acquisition series, for example, over acquisition series that follow one another in time. The speed of the processes acquired using the different acquisition modes can thus be inferred when frame data from an acquisition sequence have just been evaluated, and the durations and alternating series of the acquisition sequences of the acquisition modes can be adapted where necessary.

In an alternative to that or in addition, information that can be used to adapt the acquisition sequences can be stored in a database. Such information may have been obtained on the basis of experiments already carried out and/or on the basis of simulations.

In a further possible configuration of, the durations of the acquisition sequences can also be varied within one acquisition series.

The above-described configurations of the method can be combined with one another within routine practice of a person skilled in the art.

Techniques descried herein can be implemented by an optical device configured to acquire frame data on at least two detection channels.

The optical device comprises a detection beam path, along which detection radiation to be acquired is steered to a camera (detector). Moreover, a controller is present, which is configured to create and transmit control commands, wherein at least one light source for providing illumination radiation, optical filter elements for the controlled selection of at least one wavelength range of the illumination radiation and/or optical filter elements for the controlled selection of at least one wavelength range of the detection radiation are controlled by means of the control commands. This control serves to acquire first frame data from a first detection channel in a first acquisition mode and second frame data from a second detection channel in a second acquisition mode. The acquisition modes are determined by the respectively selected wavelength ranges of the illumination radiation and/or the detection radiation, or by the manner of the illumination, as already explained hereinbefore. The first frame data and the second frame data are acquired in respective alternating acquisition sequences of a respective acquisition series.

Characteristic of such an optical device is that the control commands of the controller are used to set the duration of the acquisition sequences of the acquisition series for each detection channel so that they differ from one another. To this end, the optical filter elements are controlled such that, as a result of their effect over the duration of the respective acquisition sequences, detection radiation of the various acquisition modes are acquired and assigned thereto.

In this case, the duration of the acquisition sequences between the acquisition series differs from the duration of the acquisition sequences of the at least one further acquisition mode at least by the duration of a single frame acquisition (frame), with the result that for temporally parallel acquisition series frame data of only one acquisition sequence are in each case acquired at a time point, and data gaps are present in the acquisition series outside of the respective acquisition sequences.

In this context, optical filter elements are understood to mean technical components and measures which thus result in a controlled acquisition of the first and second frame data. Thus, a light source may comprise a plurality of individual lasers, laser diodes and/or luminaires that emit in different wavelength ranges. It is possible to switch between the relevant individual light sources in accordance with a respectively currently selected acquisition mode by virtue of currently undesired wavelengths being prevented from illuminating the sample, for example by targeted activation and deactivation of the individual light sources or by the use of shutters or mirrors. On the illumination side, it is also possible to select and/or control optical filters such as spectral filters and/or acousto-optic filters (AOTF) in order to allow illumination wavelengths to reach the sample in accordance with a currently selected acquisition mode.

As an alternative to that or in addition, corresponding measures may be provided for the detection beam path. The acquired frame data are stored in accordance with the acquisition series and acquisition modes and the time of the acquisition thereof and are available for immediate or subsequent evaluation.

The optical device includes an appropriately configured controller or is connected to such a controller in a manner suitable for the exchange of data. The controller serves to create control commands and for example can be a computer, a microcontroller or an FPGA (field programmable gate array).

The optical device is, in particular, a constituent part of an optical apparatus for acquiring frames using a plurality of detection channels, for example of a microscope.

The optical device can be a constituent part of a light-field microscope. In such a microscope, a plurality of slice planes can be created in the direction of the detection axis (z-direction; see also) starting from a wide-field recording. A microlens array is disposed in front of the camera to this end, the microlenses of said microlens array representing an appropriate number of sub-apertures and imaging the sample to be imaged in frames with different angle information. A microscope operating according to light field theory can for example be designed the microlens array (MLA) in a spatial domain (MLA in an intermediate image plane) or in a frequency domain (MLA in a pupil plane).

In further embodiments, the optical device can be a constituent part of a microscope in which use is necessarily or advantageously made of only one camera. For example, such microscopes can illuminate the sample with different patterns, phase angles, wavelengths and/or polarizations and thus call for appropriate acquisition modes. In such an embodiment, a light source serving to provide the illumination radiation and a switching element or filter element serve to optionally create at least one of the aforementioned acquisition modes.

### BRIEF DESCRIPTION OF THE DRAWINGS

Techniques described herein are explained in detail below on the basis of exemplary embodiments and drawings, in which:

FIG. 1 shows a schematic illustration of a frame acquisition using two acquisition modes, according to the prior art;

FIG. 2 shows a schematic illustration of a frame acquisition using two acquisition modes and alternating frame acquisition, according to the prior art;

FIG. 3 shows a schematic illustration of a frame acquisition according to an example implementation, using two acquisition modes and alternating frame acquisition;

FIG. 4 shows a schematic illustration of a reproduction of frames acquired according to an example implementation from a frame acquisition, using two acquisition modes and alternating frame acquisition;

FIG. 5 shows a schematic illustration of an embodiment of a microscope according to an example implementation;

FIG. 6 shows a schematic illustration of a further embodiment of a microscope according to an example implementation in the form of a light field microscope.

### DETAILED DESCRIPTION

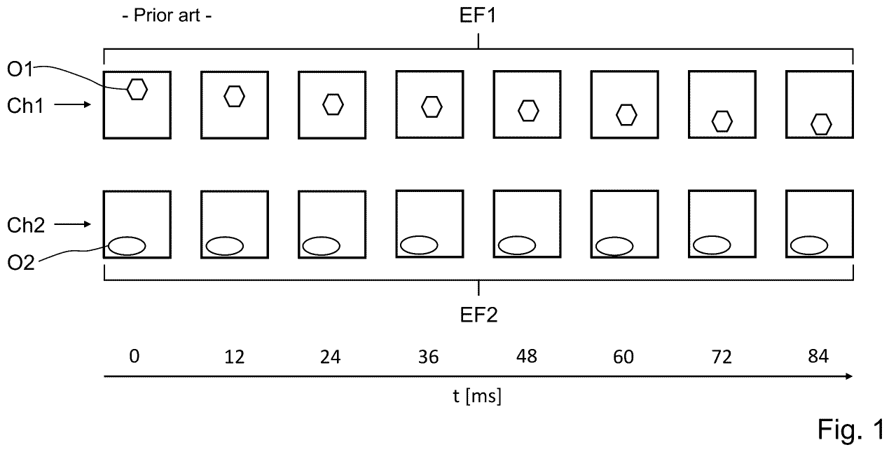

In a method for acquiring frames using two acquisition modes Ch1 and Ch2 according to the prior art, a plurality of frames (depicted as squares) are in each case acquired in two acquisition series EF1 and EF2 that are parallel in time with one another (FIG. 1). By way of example, the movement of a first object O1 (shown as a hexagon by way of example) over the duration of the first acquisition series EF1 is shown in the first acquisition mode Ch1. The first object O1 clearly changes its relative position within the frames. By contrast, a second object O2, which is acquired by means of the second acquisition mode Ch2 and represented by a horizontal oval shape, remains at its initial position for the duration of the second acquisition series EF2.

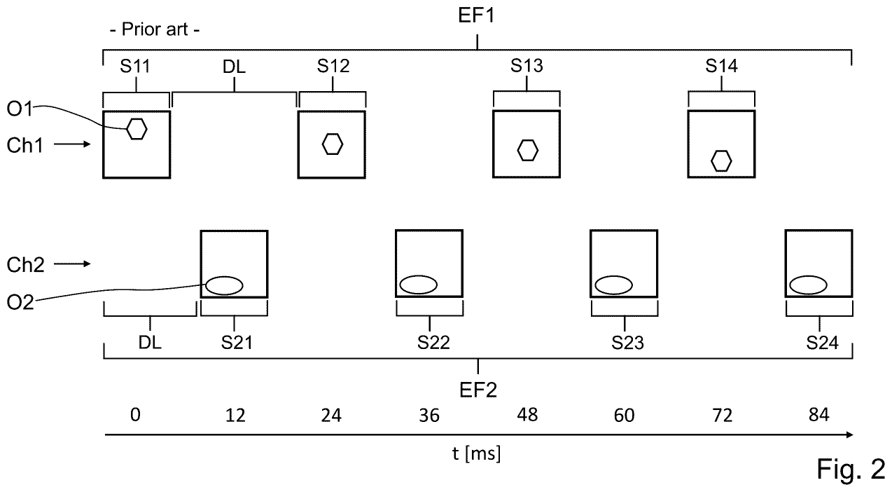

Since the two acquisition modes Ch1 and Ch2 are acquired by means of two different cameras, for example, all acquired frames can be displayed on an electronic visual display (display), for example, without data gaps DL (see FIG. 2) for the respective acquisition series EF1 and EF2.

By contrast, if the frames of the acquisition series EF1 and EF2 are acquired in alternation, acquired frames and data gaps DL alternate in each acquisition series EF1, EF2 (FIG. 2). Additionally, the objects O1 and O2, respectively, move at different speeds here in the example shown.

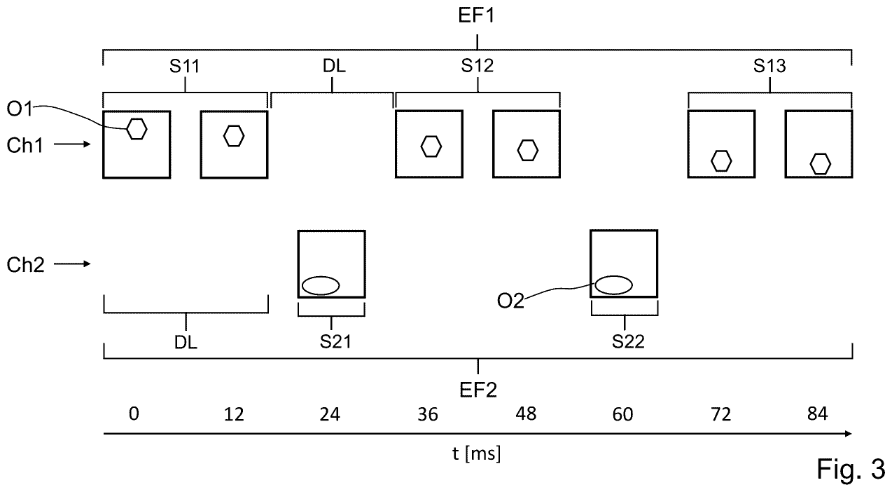

FIG. 3 schematically shows a frame acquisition according to an example implementation, using two acquisition modes and alternating frame acquisition. Since the second object O2 does not move, or moves substantially slower than the first object O1, the first object O1 is acquired more frequently than the second object O2 in a targeted manner. To this end, the frames are acquired within the first acquisition series EF1 in acquisition sequences S11 to S13, which are separated from one another by at least the acquired duration of one frame. During these data gaps DL of the first acquisition series EF1, the frames of the second acquisition series EF2 are acquired in acquisition sequences S21 and S22. The acquisition sequences S11, S12 and S13 of the first acquisition series EF1 each comprise two acquired frames, while the acquisition sequences S21 and S22 of the second acquisition series EF2 each comprise one acquired frame.

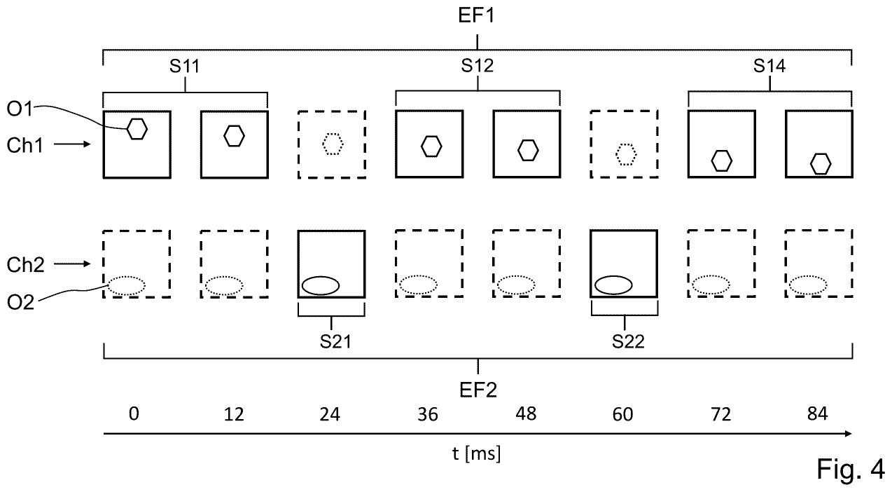

In order to be able to display the acquisition series EF1, EF2, each with data gaps DL, as completely as possible, i.e. without data gaps DL, these are filled computationally in a further configuration of the method according to an example implementation (FIG. 4). To this end, interpolations can be used to fill the relevant data gaps DL, especially in the case of fast moving objects O1. In the case of slow moving objects O2, the frame acquired directly before the relevant data gap DL can for example be copied and used to fill the adjacent data gap DL. In FIG. 4, the images inserted into the data gaps DL are shown by means of dashed lines.

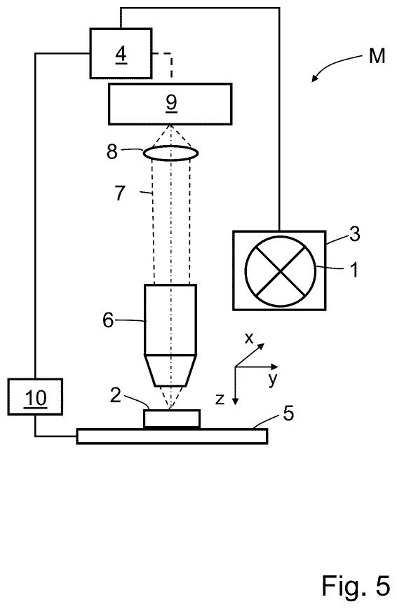

FIG. 5 shows a schematic illustration of a microscope M in the form of a wide-field microscope. The latter comprises a light source 1, for example, a laser light source, starting from which a beam of an excitation radiation is emitted and directed at a sample 2 to be imaged. Optionally present optical elements for shaping and/or collimation of the excitation radiation are not shown for the sake of better clarity.

Purely by way of example, reference sign 3 is used to symbolically represent a switching element or filter element which is connected to a controller 4 and the effect of which allows different acquisition modes in the aforementioned sense to be implemented. For example, the light source 1 may comprise a plurality of individual lasers, laser diodes or luminaires that emit in different wavelength ranges. There is switching between the relevant individual light sources in accordance with a respectively currently selected acquisition mode. This can be implemented by targeted activation and deactivation of the individual light sources or by the use of shutters or mirrors to block currently undesired wavelengths. It is also possible that, depending on the selected acquisition mode, different wavelength ranges from an emitted wavelength range of the light source 1 are filtered out or made available for the illumination by means of suitable filters (spectral filters, AOTFs).

The excitation radiation is directed into a sample space, in which the sample 2 to be imaged can be present on a sample stage 5.

Detection radiation brought about in the sample 2 by the excitation radiation is acquired by an objective 6 and guided along a detection beam path 7 (shown using dashed lines).

In a z-direction, the detection radiation arrives at an optical unit 8 which is present in the detection beam path 7 and which is used to direct the detection radiation to a camera 9.

Optionally, there is a connection suitable for exchanging data and control commands present between the light source 1 and the controller 4. For example, the controller 4 is a computer or a suitable control circuit. Optionally, the controller 4 and the camera 9 can be interconnected, for example to allow the controller 4 to generate control commands and/or validate these, on the basis of the acquired brightness information (measured values) from the camera 9. For example, these control commands serve to control the light source 1 and/or an optional drive 10 of the sample stage 5.

In particular, the controller 4 serves to carry out the methods described herein. In the process, the predetermined parameters of the acquisition series EF1, EF2, of the acquisition sequences S11 to S13, S21 to S23 and optionally properties of the data gaps DL are converted into control commands, and the method is applied by the execution thereof.

In further embodiments, the switching element 3 can additionally or alternatively be arranged in the detection beam path 7.

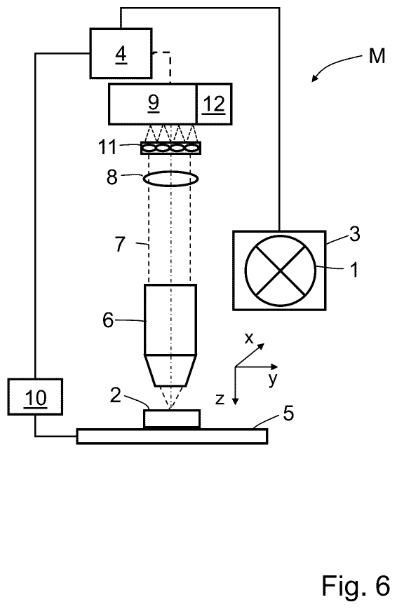

In a further embodiment, the microscope M can be embodied as a light-field microscope (FIG. 6). In this case, a microlens array 11 containing a number of microlenses (shown in simplified fashion) is arranged in front of the camera 9. The microlens array 11 is arranged in front of the camera 9 at a distance from the focal length of the microlenses and is located either in a pupil plane (Fourier light-field microscope, frequency domain light-field microscope) or in an intermediate image plane (spatial domain light-field microscope). The distance from the camera 9 can correspond to a mean focal length should the microlenses have different focal lengths in a further embodiment.

The controller 4 can be configured to handle acquired measured values from a microlens array 11 disposed upstream from the camera 9 by calculation, especially in order to combine said measured values by calculation within the sense of light field theory. To this end, the controller 4 can be provided with an integrated evaluation unit 12, for example as a microcontroller, computer, GPU or CPU. In further embodiments, the evaluation unit 12 can also be present separately from the controller 9.

Not shown are further embodiments of the microscope M, which are designed to illuminate the sample with different patterns, phase angles, wavelengths and/or polarizations and in the process bring about a respective acquisition mode. To this end, optical elements such as optical gratings, spatial light modulators (SLMs), phase element such as for example phase plates and/or filters (all not shown) can be present in an illumination beam path.

### REFERENCE SIGNS

1 Light source
2 Sample
3 Switching element
4 Controller
5 Sample stage
6 Objective
7 Detection beam path
8 Optical unit
9 Camera
10 Drive
11 Microlens array
Ch1, Ch2 Detection channel, acquisition mode
DL Data gap
EF1, EF2 Acquisition series
M Microscope
Smn Acquisition sequence (m=acquisition series; n=index of the acquisition sequence)

1. A method for acquiring frames using a plurality of detection channels, the method
comprising:
acquiring at least first frame data from a first detection channel in a first acquisition mode;
acquiring at least second frame data from a second detection channel in a second acquisition mode;
wherein the first frame data and the second frame data are acquired in respectively mutually alternating acquisition sequences of a respective acquisition series;
wherein the first and second frame data are acquired using a single camera, and
wherein a duration of the acquisition sequences of the acquisition series are chosen differently for each detection channel, with the duration of the acquisition sequences in one of the acquisition modes differing from the duration of acquisition sequences of at least one further acquisition mode at least by the duration of a single frame acquisition.

2. The method according to claim 1, wherein
artificial frame data are in each case generated for data gaps that are caused by the alternate acquisition of first and second frame data and that correspond to at least one omitted frame, the generation being brought about by either:
copying frame data acquired temporally before and/or temporally after a data gap and assigning said frame data to the omitted frames, or
calculating frame data for the omitted frames based on frame data from a detection channel acquired temporally before and/or temporally after a data gap.

3. The method according to claim 1, wherein
information specifying the duration of the acquisition sequences and of data gaps and a number of acquired or omitted frames are assigned to the frame data and to the data gaps.

4. The method according to claim 3, wherein the information additionally comprises timestamps of the acquisition series.

5. The method according to claim 1, wherein the duration of the acquisition sequences of the acquisition series for each detection channel is chosen based on a movement of imaged structures.

6. The method according to claim 1, wherein the duration of the acquisition sequences of the acquisition series for each detection channel is chosen based on an intensity of acquired frames.

7. The method according to claim 1, wherein the duration of the acquisition sequences in temporally successive acquisition series is modified.

8. The method according to claim 1, wherein the duration of the acquisition sequences is modified within an acquisition series.

9. An optical device for acquiring frame data on at least two detection channels, the optical device comprising:
a detection beam path, along which detection radiation to be acquired is steered to
a camera;
a controller configured to create and transmit control commands, wherein at least one light source for providing illumination radiation, optical filter elements for a controlled selection of at least one wavelength range of the illumination radiation, and/or optical filter elements for the controlled selection of at least one wavelength range of the detection radiation are controlled by the control commands in order to:
acquire first frame data from a first detection channel by means of the camera in a first acquisition mode, and
acquire second frame data from a second detection channel by means of the camera in a second acquisition mode, the acquisition modes being determined by respectively selected wavelength ranges of the illumination radiation and/or the detection radiation, and
in order to acquire the first frame data and the second frame data in respective alternating acquisition sequences of a respective acquisition series,
wherein the control commands of the controller are used to set a duration of the acquisition sequences of the acquisition series for each detection channel so that they differ from one another, by virtue of the optical filter elements being controlled such that, as a result of their effect over the duration of the respective acquisition sequences, detection radiation of each detection channels is acquired and assigned thereto,
wherein the duration of the acquisition sequences from one detection channel differs from the duration of acquisition sequences of the at least one further detection channel (Ch1,Ch2) at least by the duration of a single frame acquisition, with the result that for temporally parallel acquisition series frame data of only one acquisition sequence are in each case acquired at a time point, and data gaps are present in the acquisition series outside of the respective acquisition sequences.

10. A microscope comprising an optical device for acquiring frame data on at least two detection channels, the optical device comprising:
a detection beam path, along which detection radiation to be acquired is steered to a camera;
a controller configured to create and transmit control commands, wherein at least one light source for providing illumination radiation, optical filter elements for controlled selection of at least one wavelength range of the illumination radiation, and/or optical filter elements for the controlled selection of at least one wavelength range of the detection radiation are controlled by the control commands in order to:
acquire first frame data from a first detection channel by means of the camera in a first acquisition mode, and
acquire second frame data from a second detection channel by means of the camera in a second acquisition mode, the acquisition modes being determined by respectively selected wavelength ranges of the illumination radiation and/or the detection radiation, and
in order to acquire the first frame data and the second frame data in respective alternating acquisition sequences of a respective acquisition series,
wherein the control commands of the controller are used to set a duration of the acquisition sequences of the acquisition series for each detection channel so that they differ from one another, by virtue of the optical filter elements being controlled such that, as a result of their effect over the duration of the respective acquisition sequences, detection radiation of each detection channel is acquired and assigned thereto,
wherein the duration of the acquisition sequences from one detection channel differs from the duration of acquisition sequences of at least one further detection channel at least by the duration of a single frame acquisition, with the result that for temporally parallel acquisition series frame data of only one acquisition sequence are in each case acquired at a time point, and data gaps are present in the acquisition series outside of the respective acquisition sequences.

11. The microscope according to claim 10, wherein the microscope includes a light-field microscope.

12. The microscope according to claim 10, wherein the microscope is designed to illuminate a sample with different patterns, phase angles, wavelengths and/or polarizations and thereby bring about a respective acquisition mode.
